(19) United States
(12) Patent Application Publication
(10) Pub. No.: US 2026/0318473 A1
(43) Pub. Date: Oct. 15, 2026

(54) ANGLE ADJUSTMENT DEVICE FOR PHOTOGRAPHY SUPPORT FRAME AND PHOTOGRAPHY SUPPORT FRAME

(71) Applicant: SHENZHEN LEQI INNOVATION CO., LTD., SHENZHEN (CN)

(72) Inventors: CHEN WANG, SHENZHEN (CN); SHAORUI TANG, SHENZHEN (CN)

(21) Appl. No.: 19/635,796

(22) Filed: Apr. 1, 2026

(30) Foreign Application Priority Data
Apr. 14, 2025 (CN) 202520699559.1

(51) Int. Cl. F16M 11/24; G03B 17/56

(52) U.S. Cl. CPC F16M 11/245; G03B 17/561; F16M 2200/024

(57) ABSTRACT

An angle adjustment device for a photography support frame is provided. The photography support frame includes support legs, and the angle adjustment device is configured to adjust rotation angles of the support legs. The angle adjustment device includes a base and multiple rotating bases. A periphery of the base is provided with multiple protrusions, and an outer surface of each protrusion is defined with multiple grooves. Each rotating base includes an end connected to one support leg and the other end defined with an opening configured to receive one protrusion. Each rotating base is provided with a locking assembly, including a carrier plate and an operating block disposed on the carrier plate. The carrier plate is capable of horizontally sliding in the opening. The operating block is partially exposed at a bottom of the opening and capable of engaging with or disengaging from any one of the multiple grooves.

### TECHNICAL FIELD

The present disclosure relates to the technical field of photography equipment, and in particular, to an angle adjustment device for a photography support frame and a photography support frame.

### BACKGROUND

As crucial supporting devices, photography support frames are widely used in both professional and amateur scenarios to provide stable support for cameras and camcorders. In shooting tasks that require precise composition or long exposure, the stability of the photography support frame and its angle adjustment capabilities are particularly important. The support leg angle adjustment directly determines the adaptability of the equipment to different terrains and shooting requirements, making it a core factor in enhancing shooting efficiency and image quality.

Currently, angle adjustment devices for photography support frames on the market typically rely on manual operation. For example, the support leg angle adjustment is commonly controlled by a locking block mechanism. User needs to use a wrench to loosen screws to release the angle adjustment device, adjust the support legs to a desired angle, and then re-tighten the screws to lock the angle in place.

However, such an adjustment method in related art is cumbersome and inefficient, particularly in dynamic shooting scenarios where angles need to be switched quickly.

### SUMMARY

The present disclosure provides an angle adjustment device for a photography support frame, aiming to address the issues of cumbersome angle adjustment of support legs in related photography support frames.

To realize the above objective, the present disclosure provides an angle adjustment device for a photography support frame. The photography support frame includes support legs, and the angle adjustment device is configured to adjust rotation angles of the support leg. The angle adjustment device includes:
a base, a periphery of the base being provided with a plurality of protrusions configured to connect the support legs, and an outer surface of each protrusion being defined with a plurality of grooves; and
a plurality of rotating bases, each rotating base including an end connected to one of the support legs and the other end being defined with an opening configured to receive one of the plurality of protrusions, and each rotating base being provided with a locking assembly.

The locking assembly includes a carrier plate and an operating block disposed on the carrier plate, the carrier plate is capable of horizontally sliding in the opening, and the operating block is partially exposed at a bottom of the opening and is capable of engaging with or disengaging from any one of the plurality of grooves. When the operating block engages in one of the plurality of grooves, the rotating base is prevented from rotating relative to the base; and when the operating block disengages from the groove, the rotating base is capable of rotating relative to the base.

In some embodiments, a first elongated slot is defined in a side of the carrier plate facing away from the operating block, and the first elongated slot extends in a length direction of the carrier plate. A first limiting post adapted to the first elongated slot is provided at the bottom of the opening, and the first limiting post is inserted into the first elongated slot to limit a travel of the carrier plate.

In some embodiments, the first elongated slot is located at a central region of the carrier plate. The carrier plate is further defined with a second elongated slot and a third elongated slot, the second elongated slot is located on a side of the first elongated slot, and the third elongated slot is located on the other side of first elongated slot. A second limiting post adapted to the second elongated slot and a third limiting post adapted to the third elongated slot are further provided at the bottom of the opening.

In some embodiments, the locking assembly further includes two reset members. One of the two reset members is disposed at an end of the second elongated slot and abuts against the second limiting post, and the other one of the two reset members is disposed at an end of the third elongated slot and abuts against the third limiting post.

In some embodiments, a recessed insertion slot is defined in a side of the carrier plate where the operating block is arranged, the insertion slot is located at an end of the carrier plate, and the insertion slot is communicated with both the second elongated slot and the third elongated slot. The locking assembly further includes an insertion plate capable of being inserted into the insertion slot, and the two reset members abut against the insertion plate.

In some embodiments, the insertion slot is further communicated with the first elongated slot, and at least one selected from a group consisting of the first limiting post and the insertion plate is a magnetic attraction member.

In some embodiments, the locking assembly further includes an operating plate configured for a user to operate. The operating plate is connected to an end of the carrier plate facing away from the insertion slot and is exposed from the opening.

In some embodiments, the operating plate is integrally formed with the carrier plate.

In some embodiments, the opening is defined by two opposing sidewalls, and each of the two opposing sidewalls is defined with a guide groove. The guide grooves are configured to guide the carrier plate to slide horizontally along the bottom of the opening.

The present disclosure further provides a photography support frame, including the angle adjustment device according to any one of the foregoing embodiments.

According to the present disclosure, by arranging a slidable operating block on the rotating base and operating the carrier plate to slide horizontally in the opening, the operating block can be brought into contact with or separated from any one of the grooves defined in the protrusion, thereby achieving convenient adjustment and locking of the angle of the supporting leg. When the operating block slides to a position where it abuts against a certain groove, the operating block extends into that groove and forms an abutment, thereby preventing the rotating base from rotating relative to the base and achieving the effect of locking the angle of the supporting leg. When the sliding block slides to a position separated from that groove, the operating block disengages from the groove and no longer restricts the rotation of the rotating base, allowing the user to freely adjust the angle of the supporting legs. Compared with conventional angle adjustment devices, the angle adjustment device provided herein requires no additional tools or complicated operational steps. The user can lock and unlock the angle simply by sliding the operating block.

### BRIEF DESCRIPTION OF THE DRAWINGS

FIG. 1 is a structural schematic diagram of an angle adjustment device for a photography support frame according to an embodiment of the present disclosure.

FIG. 2 is an exploded schematic diagram of the angle adjustment device for a photography support frame according to an embodiment of the present disclosure.

FIG. 3 is an exploded schematic diagram of an angle adjustment device for a photography support frame according to another embodiment of the present disclosure.

FIG. 4 is an enlarged view of portion A in FIG. 3.

FIG. 5 is a front view of an angle adjustment device for a photography support frame according to an embodiment of the present disclosure.

FIG. 6 shows a cross-section taken along line B-B in FIG. 5, as seen from a perspective different from that corresponding to line B-B.

FIG. 7 shows a cross-section taken along line C-C in FIG. 5, as seen from a perspective different from that corresponding to line C-C.

The realization of the objectives, functional features, and advantages of the present disclosure will be further described in conjunction with the embodiments and with reference to the accompanying drawings.

### DETAILED DESCRIPTION OF THE EMBODIMENTS

The technical solutions in the embodiments of the present disclosure will be described clearly and completely with reference to the accompanying drawings in the embodiments of the present disclosure. Obviously, the described embodiments are only a part of the embodiments of the present disclosure rather than all of them. Based on the embodiments in the present disclosure, all other embodiments obtained by those skilled in the art without creative work shall fall within the scope of protection of the present disclosure.

It should be noted that all directional indications (such as up, down, left, right, front, back) in the embodiments of the present disclosure are merely used to explain relative position relationships or motion conditions between the components in a specific attitude (as shown in the drawings). The directional indication changes as the specific attitude changes.

It should also be noted that when an element is referred to as being “mounted on” or “disposed on” another element, it may be directly on the other element, or intervening elements may also be present. When an element is referred to as being “connected to” another element, it may be directly connected to the other element, or intervening elements may also be present.

Moreover, the terms “first”, “second”, and the like in the present disclosure are merely used for description and cannot be understood as indicating or implying their relative importance or as implicitly indicating the quantity of the technical features indicated. Thus, the feature defined by “first” or “second” may explicitly or implicitly include at least one such feature. In addition, the technical solutions of various embodiments may be combined with each other, but must be based on that the combined technical solutions can be implemented by those skilled in the art. When the combination of the technical solutions is contradictory or impossible to realize, it shall be considered that such combination does not exist and is not within the scope of protection of the present disclosure.

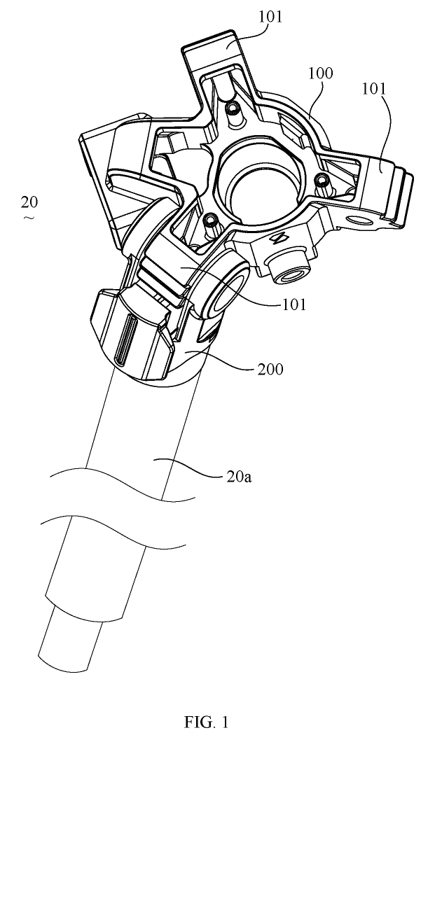

In some embodiments, with reference to FIGS. 1-3, the present disclosure provides an angle adjustment device 10 for a photography support frame 20. The photography support frame 20 includes support legs 20a. The angle adjustment device 10 is configured to adjust rotation angles of the support legs 20a. The angle adjustment device 10 includes a base 100 and a plurality of rotating seats 200.

A plurality of protrusions 101 are provided on a periphery of the base 100 for connecting the support legs 20a, and an outer surface of each protrusion 101 is defined with multiple grooves 101a.

Each rotating seat 200 includes one end connected to a tube component of one support leg 20a and the other end defined with an opening 200a for accommodating one protrusion 101. Each rotating seat 200 is provided with a locking assembly 300.

The locking assembly 300 includes a carrier plate 301 and an operating block 302 disposed on the carrier plate 301. The carrier plate 301 is capable of sliding horizontally in the opening 200a. The operating block 302 is partially exposed at the bottom of the opening 200a, and is capable of engaging with or disengaging from any one of the plurality of grooves 101a. When the operating block 302 engages in one groove 101a, the rotating seat 200 is prevented from rotating relative to the base 100; when the operating block 302 disengages from the groove 101a, the rotating seat 200 is allowed to rotate relative to the base 100.

In the embodiments, the base 100 serves as the support base and connection mechanism for the entire angle adjustment device 10, providing stable support and allowing the support legs 20a to be adjusted at multiple angular positions. In some embodiments, the base 100 is made of a material such as aluminum alloy, high-strength engineering plastic, or stainless steel, offering characteristics like lightweight, high strength, and corrosion resistance. In some embodiments, the base 100 is configured in the shape of a disc, a polygon, or another desired shape. Three protrusions 101 are arranged on the periphery of the base 100, forming a tripod mount which is commonly used in the photographic industry. However, this configuration is merely illustrative. In other embodiments, four or five protrusions 101 can be provided on the periphery of the base 100, and the number of protrusions 101 is not limited thereto.

In the embodiments, the rotating seat 200 is configured to connect the support leg 20a and provide an adjustable rotating mechanism. The rotating seat 200 serves as an intermediate connecting mechanism linking the base 100 and the support leg 20a. One end of the rotating seat 200 is connected to the tube component of the support leg 20a, and the other end of the rotating seat 200 is defined with the opening 200a for accommodating the protrusion 101 on the base 100. The rotating seat 200 is provided with the locking assembly 300, which is configured to lock the relative rotation of the rotating seat 200 relative to the protrusion 101. In the embodiments, the locking assembly 300 includes the carrier plate 301 that is capable of sliding horizontally in the opening 200a. The operating block 302 is disposed on the carrier plate 301 and partially exposed at the bottom of the opening 200a. The operating block 302 is capable of engaging with or disengaging from any one of the plurality of grooves 101a. When the operating block 302 engages in one of the grooves 101a, the rotating seat 200 is prevented from rotating relative to the base 100; when the operating block 302 disengages from the groove 101a, the rotating seat 200 is allowed to rotate relative to the base 100.

Users may proceed as follows to operate the angle adjustment device 10. First, the carrier plate 301 is pulled to move in a first direction, driving the operating block 302 to a first position. At the first position, the operating block 302 disengages from one groove 101a of the protrusion 101, allowing the rotating seat 200 to be rotated relative to the protrusion 101 for angle adjustment. After a desired angle is reached, the carrier plate 301 is pushed in a second direction, driving the operating block 302 to a second position (i.e., a reset position). At this stage, the rotating seat 200 has been rotated to a certain angle, the operating block 302 which has moved to the second position abuts against another protrusion 101 and engages with another groove 101a, thereby preventing the rotating seat 200 from rotating relative to the base 100 and achieving a locked state.

In another operation mode, the user can first rotate the rotating seat 200 to its maximum opening angle, allowing the operating block 302 to engage in one of the grooves 101a. Subsequently, the user can directly push the rotating seat 200 or the support leg 20a to achieve angle readjustment. When the rotating seat 200 or the support leg 20a is pushed, since the plurality of grooves 101a each has a unidirectional slope, the operating block 302 is driven by the rotating seat 200 to slide out of the current groove 101a and then, under the influence of gravity, slides into another groove 101a . In this way, the user does not need to operate the carrier plate 301 and can focus more attention on finding a appropriate shooting angle, thereby improving the efficiency of the actual shooting work.

In the embodiments, a slidable operating block 302 is arranged on the rotating seat 200. By operating the carrier plate 301 to slide horizontally in the opening 200a, the operating block 302 can engage with or disengage from any one of the plurality of grooves 101a, thereby enabling convenient adjustment and locking of the angle of the support leg 20a. When the operating block 302 slides to a position where it engages in the groove 101a, the operating block 302 is inserted into the groove 101a, forming an abutment that prevents the rotating seat 200 from rotating relative to the base 100, thus locking the support leg 20a. When the operating block 302 slides to a position where it disengages from the groove 101a, the operating block 302 withdraws from the groove 101a and no longer restricts rotation of the rotating seat 200, allowing the user to freely adjust the angle of the support leg 20a. Compared with conventional angle adjustment devices, the angle adjustment device 10 provided herein requires no additional tools or complicated operational steps, offering simple and intuitive operation, thereby improving the practicality and convenience of the photography support frame 20.

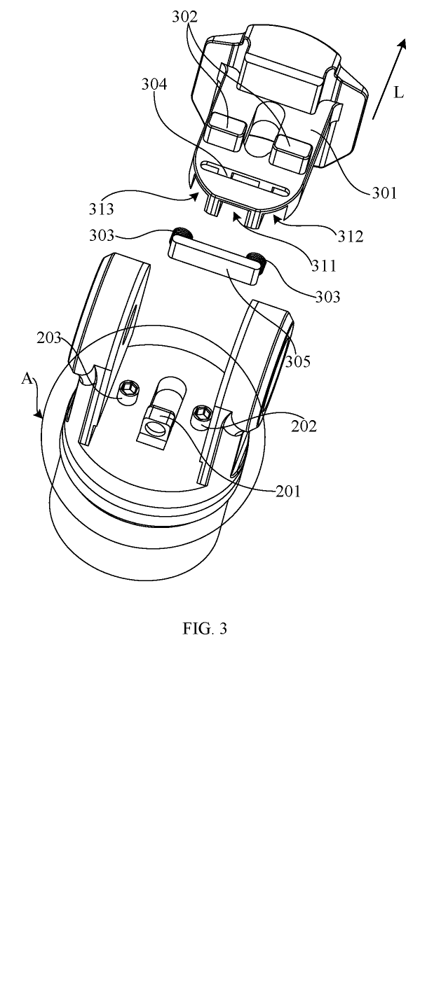

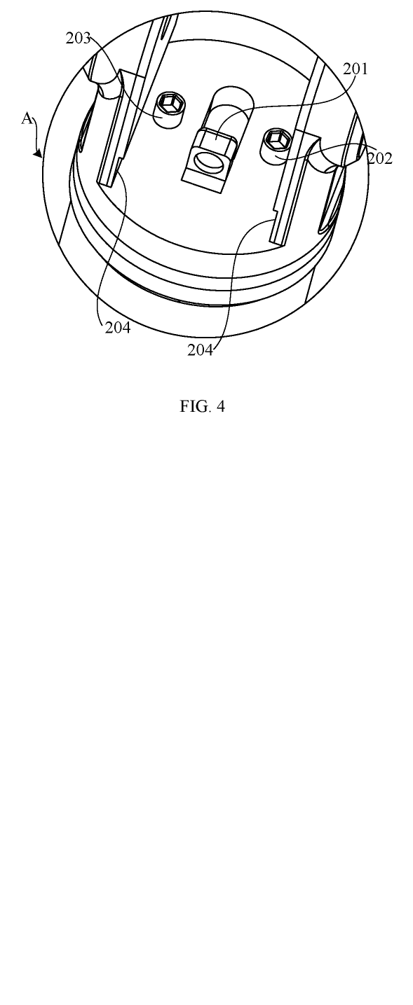

In some embodiments, with reference to FIGS. 3 and 4, the side of the carrier plate 301 facing away from the operating block 302 is defined with a first elongated slot 311 extending in a length direction L of the carrier plate 301. A first limiting post 201 adapted to the first elongated slot 311 is provided at the bottom of the opening 200a. The first limiting post 201 is inserted into the first elongated slot 311 to restrict the travel of the carrier plate 301.

In the embodiments, the arrangement of the first elongated slot 311 and the first limiting post 201 allows the carrier plate 301 to slide horizontally relative to the rotating seat 200, and also limits the travel of the carrier plate 301, ensuring that the carrier plate 301 can accurately move between the first position and the second position. This makes the movement of the carrier plate 301 smoother and more controllable, preventing structural damage or functional failure caused by excessive displacement of the carrier plate 301 during operation.

In some embodiments, to address the issue of the carrier plate 301 potentially moving unintentionally from the second position under an external force, a first locking member is provided on the first limiting post 201. In some embodiments, the first locking member is a snap-fit structure; correspondingly, a groove is defined in the inner wall of the first elongated slot 311. Thus, the cooperation between the groove and the snap-fit structure can realize relative fixation, thereby keeping the operating block 302 in the second position. The locking mechanism ensures that the carrier plate 301 remains stably locked during photography, even when subjected to vibration or accidental collision, thereby enhancing the stability and reliability of the entire support stand.

In some other embodiments, the first locking member is a magnet, and the carrier plate 301 is made of a magnetic-attractable metal material, such as ferrous alloy, nickel-plated metal, or ferrous metal. This allows the first locking member to be directly attracted to the inner wall of the first elongated slot 311. Alternatively, another magnet is provided inside the first elongated slot 311, forming a magnet-to-magnet attraction that generates a stronger locking force.

In some embodiments, in the configuration that the first locking member is a snap-fit structure, to further enhance the reliability and service life of the locking mechanism, the snap-fit structure is made of an elastic material, such as spring steel or high-strength engineering plastic, ensuring that the first locking member maintains good elasticity and locking performance even after prolonged use. In the magnetic locking configuration, high-performance rare-earth permanent magnet materials, such as neodymium iron boron, can be selected, which offer characteristics such as compact size, strong magnetic force, and good stability.

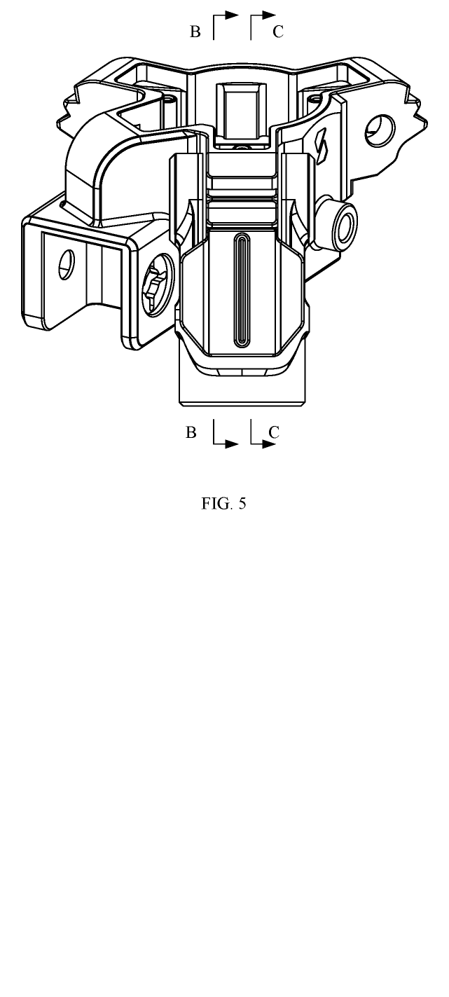

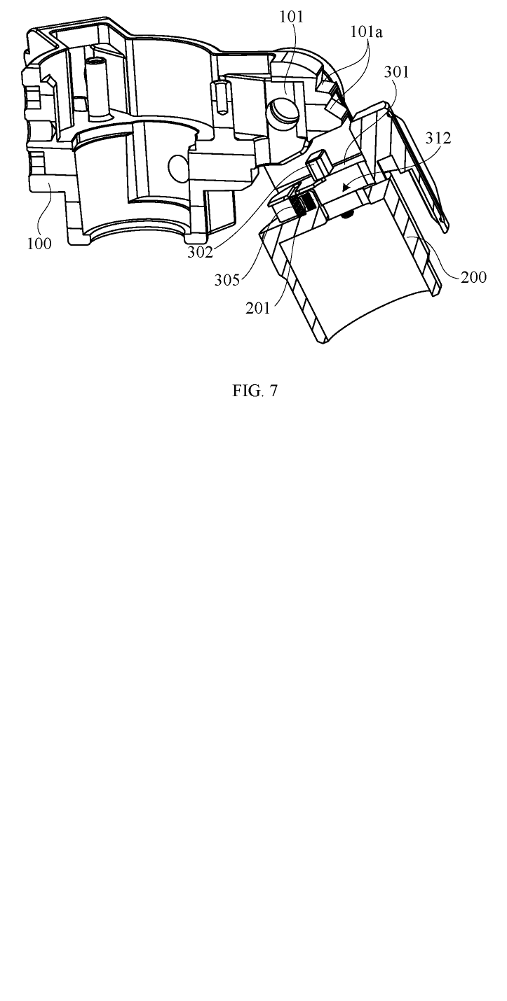

In some embodiments, with reference to FIGS. 3-7, the first elongated slot 311 is located at a central region of the carrier plate 301. The carrier plate 301 is further defined with a second elongated slot 312 and a third elongated slot 313 located on both sides of the first elongated slot 311. A second limiting post 202 and a third limiting post 203, which are respectively adapted to the second elongated slot 312 and the third elongated slot 313, are further provided at the bottom of the opening 200a.

In the embodiments, on the basis of the first elongated slot 311, the second elongated slot 312 and the third elongated slot 313 that are parallel to the first elongated slot 311 are additionally provided; and the second limiting post 202 and the third limiting post 203, which are respectively adapted to the second elongated slot 312 and the third elongated slot 313, are disposed at the bottom of the opening 200a of the rotating seat 200. This multi-slot and multi-post configuration forms a more comprehensive guiding system, making the sliding of the carrier plate 301 smoother and more controllable.

First, the cooperation between the multiple elongated slots and the multiple limiting posts provides a more precise guiding function, ensuring a more linear sliding trajectory of the carrier plate 301 in the horizontal direction. This prevents deviation or wobbling that may occur with single-slot guidance, thereby improving operational precision.

Second, the three-point support configuration significantly enhances the overall structural stability of the locking assembly 300, effectively preventing potential tilting or jamming of the carrier plate 301 when subjected to uneven forces. This ensures that the engagement between the operating block 302 and the groove 101a remains precisely aligned even when operating on uneven ground or in strong wind conditions.

Additionally, the multi-point contact disperses the stress experienced by the carrier plate 301 during operation, reducing localized wear and significantly extending the service life of the angle adjustment device 10. This enhanced durability is particularly important in professional photography scenarios involving high-frequency adjustments.

In some embodiments, referring to FIGS. 3 and 4, the locking assembly 300 further includes two reset members 303. One reset member 303 is arranged at an end of the second elongated slot 312 and abuts against the second limiting post 202. The other reset member 303 is arranged at an end of the third elongated slot 313 and abuts against the third limiting post 203.

In the embodiments, the two reset members 303 are configured to provide driving force for the carrier plate 301 to move to the first position (i.e., the reset position). This represents a significant improvement over the previous embodiments, where resetting primarily relied on gravity or gravitational force, which may unstable or unreliable in practical operating environments. In some embodiments, the reset members 303 are compression springs, which possess favorable elastic recovery characteristics and can provide stable and predictable pushing forces.

During operation, the user first pulls the carrier plate 301 to move, causing the operating block 302 to move to the second position. At this point, the first locking member on the first limiting post 201 and the inner wall of the first elongated slot 311 magnetically attract each other, thereby stably holding the operating block 302 in the second position. Simultaneously, the reset members 303 in the second elongated slot 312 and the third elongated slot 313 abut against the second limiting post 202 and the third limiting post 203 respectively, and are compressed during this process, thereby storing elastic potential energy. At this moment, the user can directly operate the rotating seat 200 to freely adjust the angle of the support leg 20a.

After adjusting to an appropriate angle, the user gently pushes the carrier plate 301 to release the locked state (i.e., overcoming the magnetic attraction between the first locking member and the inner wall of the first elongated slot 311). At this moment, under the simultaneous pushing force of the two reset members 303, the carrier plate 301 drives the operating block 302 to move quickly and smoothly to the first position (i.e., the reset position). Consequently, the operating block 302 precisely extends into the groove 101a of the protrusion 101, thereby securely fixing the angle of the rotating seat 200.

Thereafter, if the user needs to further adjust the position of the support leg 20a, the user can apply a downward force on the rotating base 200 (pressing downward relative to the horizontal plane). This drives the operating block 302 to slide smoothly out of the current groove 101a, allowing the carrier plate 301 to move while simultaneously compressing the reset members 303 again. The reset members 303 store energy and provide elastic supporting to the carrier plate 301. As the operating block 302 slides into the next groove 101a, the reset members 303 release their pushing force, pushing the carrier plate 301 and driving the operating block 302 to insert more deeply within the groove 101a, thereby ensuring locking reliability.

The symmetrical arrangement of the dual reset members 303 ensures balanced force on the carrier plate 301 during the movement of the carrier plate 301. This avoids the torque imbalance that a single-side spring might cause, thereby ensuring a smoother and more controllable operational process.

In some embodiments, referring further to FIG. 3, a recessed insertion slot 304 is defined in the side of the carrier plate 301 where the operating block 302 is provided. The insertion slot 304 is located at an end of the carrier plate 301 and communicated with both the second elongated slot 312 and the third elongated slot 313. The locking assembly 300 further includes an insertion plate 305, which is capable of being inserted into the insertion slot 304. The two reset members 303 abut against the insertion plate 305.

In the embodiments, the insertion slot 304 is defined in the carrier plate 301 and communicated with both the second elongated slot 312 and the third elongated slot 313; the reset members 303 may be directly mounted on the detachable insertion plate 305. This modular design facilitates easier installation, replacement, and maintenance of the reset members 303. The insertion plate 305 is configured as an independent part that can be easily inserted or removed as needed, greatly simplifying the manufacturing process and subsequent maintenance of the device.

When the reset members 303 require replacement or maintenance, the user only needs to remove the insertion plate 305 without disassembling the entire angle adjustment device 10, thereby enhancing the maintainability and service life of the device.

Additionally, the insertion plate 305 allows for the quick replacement of reset members 303 of different specifications to suit various usage scenarios. For instance, a reset member 303 with a high elastic coefficient can be installed for heavy photographic equipment, while a reset member 303 with a low elastic coefficient can be used for lightweight equipment. This provides greater adaptability and customization possibilities for the user.

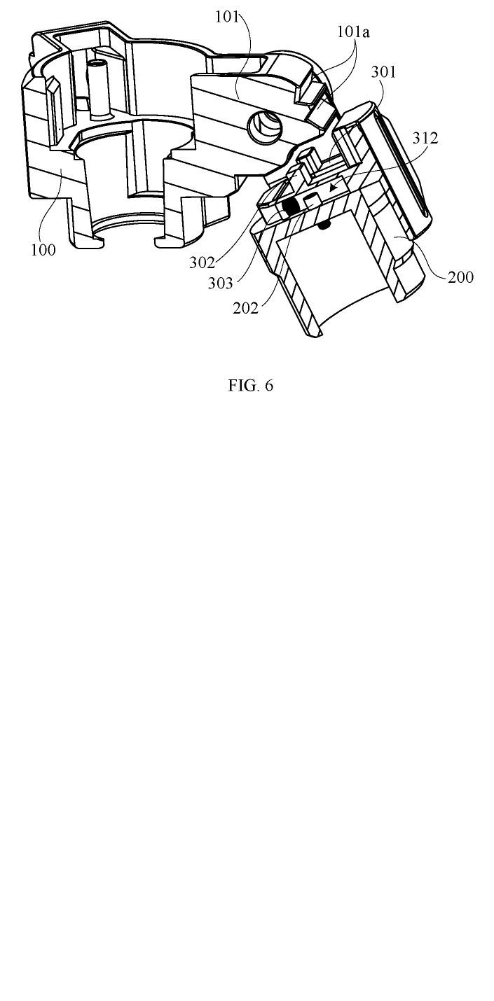

In some embodiments, referring to FIGS. 3 and 6, the insertion slot 304 is further communicated with the first elongated slot 311, and at least one selected from a group consisting of the first limiting post 201 and the insertion plate 305 is a magnetic attraction member.

In the embodiments, the insertion slot 304 is communicated with all of the first elongated slot 311, the second elongated slot 312, and the third elongated slot 313, realizing a more integrated solution. The insertion plate 305 is made of a magnetic material (such as ferrous metal or a permanent magnetic material), and the reset members 303 are directly mounted on the insertion plate 305. The material selection for the carrier plate 301 is no longer constrained by magnetic requirements. The carrier plate 301 can be made of plastic, aluminum alloy, or any other non-magnetic material, provided that at least one selected from a group consisting of the insertion plate 305 and the first limiting post 201 possesses the magnetic attraction capability to enable the locking function.

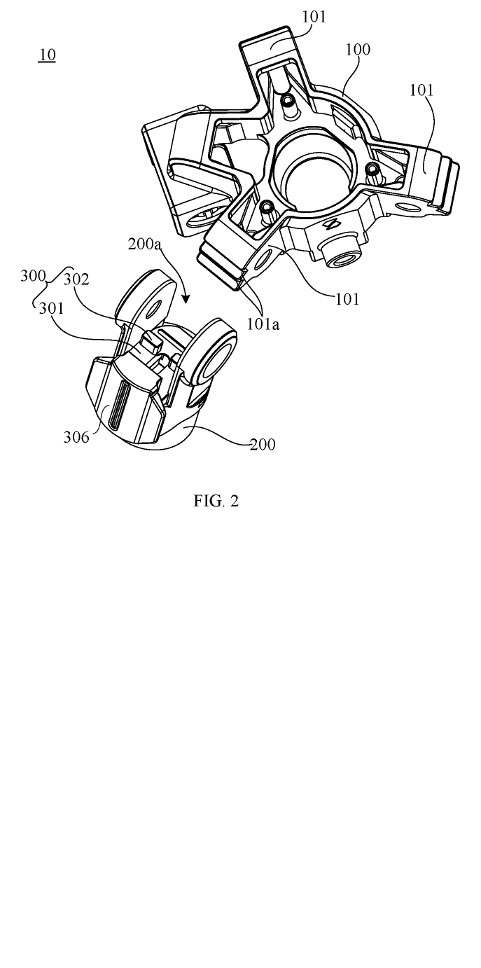

In some embodiments, referring to FIG. 2, the locking assembly 300 further includes an operating plate 306 for user operation. The operating plate 306 is connected to the end of the carrier plate 301 away from the insertion slot 304 and is exposed through the opening 200a.

The operating plate 306 is configured to provide a structure that is easy for a user to grip and operate. This increases the operable area and thereby facilitate the pulling of the carrier plate 301. The operating plate 306 is disposed at the end of the carrier plate 301 away from the insertion slot 304 and is exposed through the opening 200a, ensuring direct access without the need for special tools or complex maneuvers.

In some embodiments, the operating plate 306 is integrally formed with the carrier plate 301. This not only enhances structural strength, avoiding potential loosening or breakage at the connection, but also simplifies the manufacturing process and reduces production costs.

The design of the operating plate 306 being integrally formed with the carrier plate 301 improves structural strength, avoids additional assembly steps, streamlines production, and reduces the risk of operational errors caused by connection looseness, enhancing the reliability and durability of the entire adjustment device.

The operating plate 306 optimizes operational experience, allowing the angle adjustment of the photography support frame 20 more intuitive, convenient, and reliable.

In some embodiments, referring to FIGS. 3 and 4, the opening 200a is defined by two opposing sidewalls, and each of the two opposing sidewalls is defined with a guide groove 204. The guide grooves 204 are configured to guide the carrier plate 301 to slide horizontally along the bottom of the opening 200a.

In the embodiments, the guide grooves 204 are defined in the two opposing sidewalls of the opening 200a of the rotating base 200, to provide additional guidance and support for the horizontal sliding motion of the carrier plate 301. The guide grooves 204 are matched to the edges of the carrier plate 301. During horizontal movement of the carrier plate 301, the edges of the carrier plate 301 slide within the guide grooves 204. This ensures that the movement trajectory of the carrier plate 301 remains strictly within a predetermined plane, thereby preventing any vertical wobble or deviation in the vertical direction.

The present disclosure further provides a photography support frame 20, including the angle adjustment device 10 described in any of the foregoing embodiments. The specific structure of the angle adjustment device 10 can refer to the foregoing embodiments. Since the photography support frame 20 incorporates all technical solutions from all the foregoing embodiments, it at least possesses all the technical effects brought by the technical solutions of those embodiments, which is not detailed herein.

In the embodiments, the photography support frame 20 systematically integrates the angle adjustment device 10 with other photographic support components, such as support legs 20a, connecting tubes, and a pan-tilt head, thereby forming a complete and fully-functional photographic support system. The angle adjustment device 10, serving as the core component of the photography support frame, provides reliable assurance for the precise angle adjustment of the support legs 20a.

In some embodiments, each support leg 20a is made of lightweight yet high-strength carbon fiber material and is tightly connected to an end of the corresponding rotating base 200, enabling precise angle positioning and stable locking under the control of the angle adjustment device 10. In some embodiments, considering adaptability to various ground environments, the bottoms of the support legs 20a are provided with rubber pads and metal spikes, making them suitable for use in different ground environments.

In some embodiments, the pan-tilt head located on the upper portion of the photography support frame incorporates a fluid damping design, providing smooth rotation for photographic equipment. The pan-tilt head works in coordination with the angle adjustment device 10 located on the lower portion of the photography support frame, together enabling comprehensive positional control ranging from coarse to fine adjustments.

In the embodiments, by systematically integrating the advantages of all the foregoing technical solutions, the photography support frame 20 of the present disclosure is user-friendly in operation, precise in adjustment, reliable in locking, and highly adaptable.

The above are only some embodiments of the present disclosure, and neither the words nor the drawings can limit the protection scope of the present disclosure. Any equivalent structural transformation made by using the contents of the specification and the drawings of the present disclosure under the overall concept of the present disclosure, or directly/indirectly applied in other related technical fields are included in the protection scope of the present disclosure.

What is claimed is:

1. An angle adjustment device for a photography support frame, the photography support frame comprising support legs, and the angle adjustment device being configured to adjust rotation angles of the support legs; wherein the angle adjustment device comprises:
a base, a periphery of the base being provided with a plurality of protrusions configured to connect the support legs, and an outer surface of each protrusion being defined with a plurality of grooves; and
a plurality of rotating bases, each rotating base comprising an end connected to one of the support legs and the other end being defined with an opening configured to receive one of the plurality of protrusions, and each rotating base being provided with a locking assembly;
wherein the locking assembly comprises a carrier plate and an operating block disposed on the carrier plate, the carrier plate is capable of horizontally sliding in the opening, and the operating block is partially exposed at a bottom of the opening and is capable of engaging with or disengaging from any one of the plurality of grooves; when the operating block engages in one of the plurality of grooves, the rotating base is prevented from rotating relative to the base; and when the operating block disengages from the groove, the rotating base is capable of rotating relative to the base.

2. The angle adjustment device of claim 1, wherein,
a first elongated slot is defined in a side of the carrier plate facing away from the operating block, and the first elongated slot extends in a length direction of the carrier plate; and
a first limiting post adapted to the first elongated slot is provided at the bottom of the opening, and the first limiting post is inserted into the first elongated slot to limit a travel of the carrier plate.

3. The angle adjustment device of claim 2, wherein,
the first elongated slot is located at a central region of the carrier plate;
the carrier plate is further defined with a second elongated slot and a third elongated slot, wherein the second elongated slot is located on a side of the first elongated slot, and the third elongated slot is located on the other side of first elongated slot; and
a second limiting post adapted to the second elongated slot and a third limiting post adapted to the third elongated slot are further provided at the bottom of the opening.

4. The angle adjustment device of claim 3, wherein the locking assembly further comprises two reset members; wherein,
one of the two reset members is disposed at an end of the second elongated slot and abuts against the second limiting post, and the other one of the two reset members is disposed at an end of the third elongated slot and abuts against the third limiting post.

5. The angle adjustment device of claim 4, wherein,
a recessed insertion slot is defined in a side of the carrier plate where the operating block is arranged, the insertion slot is located at an end of the carrier plate, and the insertion slot is communicated with both the second elongated slot and the third elongated slot; and
the locking assembly further comprises an insertion plate capable of being inserted into the insertion slot, and the two reset members abut against the insertion plate.

6. The angle adjustment device of claim 5, wherein,
the insertion slot is further communicated with the first elongated slot, and at least one selected from a group consisting of the first limiting post and the insertion plate is a magnetic attraction member.

7. The angle adjustment device of claim 5, wherein,
the locking assembly further comprises an operating plate configured for a user to operate, wherein the operating plate is connected to an end of the carrier plate facing away from the insertion slot and is exposed from the opening.

8. The angle adjustment device of claim 7, wherein,
the operating plate is integrally formed with the carrier plate.

9. The angle adjustment device of claim 1, wherein,
the opening is defined by two opposing sidewalls, and each of the two opposing sidewalls is defined with a guide groove;
wherein the guide grooves are configured to guide the carrier plate to slide horizontally along the bottom of the opening.

10. A photography support frame, comprising the angle adjustment device of claim 1.

11. The photography support frame of claim 10, wherein,
a first elongated slot is defined in a side of the carrier plate facing away from the operating block, and the first elongated slot extends in a length direction of the carrier plate; and
a first limiting post adapted to the first elongated slot is provided at the bottom of the opening, and the first limiting post is inserted into the first elongated slot to limit a travel of the carrier plate.

12. The photography support frame of claim 11, wherein,
the first elongated slot is located at a central region of the carrier plate;
the carrier plate is further defined with a second elongated slot and a third elongated slot, wherein the second elongated slot is located on a side of the first elongated slot, and the third elongated slot is located on the other side of first elongated slot; and
a second limiting post adapted to the second elongated slot and a third limiting post adapted to the third elongated slot are further provided at the bottom of the opening.

13. The photography support frame of claim 12, wherein the locking assembly further comprises two reset members; wherein,
one of the two reset members is disposed at an end of the second elongated slot and abuts against the second limiting post, and the other one of the two reset members is disposed at an end of the third elongated slot and abuts against the third limiting post.

14. The photography support frame of claim 13, wherein,
a recessed insertion slot is defined in a side of the carrier plate where the operating block is arranged, the insertion slot is located at an end of the carrier plate, and the insertion slot is communicated with both the second elongated slot and the third elongated slot; and
the locking assembly further comprises an insertion plate capable of being inserted into the insertion slot, and the two reset members abut against the insertion plate.

15. The photography support frame of claim 14, wherein,
the insertion slot is further communicated with the first elongated slot, and at least one selected from a group consisting of the first limiting post and the insertion plate is a magnetic attraction member.

16. The photography support frame of claim 14, wherein,
the locking assembly further comprises an operating plate configured for a user to operate, wherein the operating plate is connected to an end of the carrier plate facing away from the insertion slot and is exposed from the opening.

17. The photography support frame of claim 16, wherein,
the operating plate is integrally formed with the carrier plate.

18. The photography support frame of claim 10, wherein,
the opening is defined by two opposing sidewalls, and each of the two opposing sidewalls is defined with a guide groove;
wherein the guide grooves are configured to guide the carrier plate to slide horizontally along the bottom of the opening.
